(19) United States
(12) Patent Application Publication
(10) Pub. No.: US 2013/0108763 A1
(43) Pub. Date: May 2, 2013

(54) EMULSIFIED COMPOSITION, A METHOD FOR PREPARING THE SAME AND FOOD AND DRINK CONTAINING THE SAME

(71) Applicants: Masanori Saitoh, Kawasaki-shi (JP); Hayato Hori, Kawasaki-shi (JP); Hiromu Sasakura, Kawasaki-shi (JP)

(72) Inventors: Masanori Saitoh, Kawasaki-shi (JP); Hayato Hori, Kawasaki-shi (JP); Hiromu Sasakura, Kawasaki-shi (JP)

(21) Appl. No.: 13/808,631

(22) PCT Filed: Jul. 8, 2011
(86) PCT No.: PCT/JP2011/065663

§ 371 Date: Jan. 7, 2013

(30) Foreign Application Priority Data
Jul. 9, 2010 (JP) 2010-156808

(51) Int. Cl. A23L 1/035

(52) U.S. Cl. CPC A23L 1/035
USPC 426/548; 426/602; 426/590; 426/519

(57) ABSTRACT

This invention provides an emulsified composition comprising (A) edible oil material, (B) sucrose diacetate hexaisobutyrate (SAIB), (C) octenylsuccinic acid-modified gum arabic, (D) polyalcohol and (E) water, in which the particles are finer and more uniform than those in conventional emulsions prepared with gum arabic, and which is easy of preparation.

### TECHNICAL FIELD

This invention relates to an emulsified composition which is prepared using octenylsuccinic acid-modified gum arabic, whose particles are finer, more uniform and stable compared to those in conventional emulsions and which furthermore is easy of preparation; a method for preparing the same; and food and drink containing the same.

### BACKGROUND ART

Gum arabic is a natural polysaccharide obtained from secretions of leguminous perennial trees such as Acacia senegal, Acacia seyal and other plants of the same genus, which is comprised of galactose, glucuronic acid, arabinose, rhamnose and the like and has a complex structure. Gum arabic has been utilized in men's life of ancient times and is now widely put to various utilities besides that as an emulsifier, such as a stabilizer, thickener, adhesive and the like, making use of its excellent emulsifying ability and emulsifying characteristics. Whereas, being a natural product, its quality is erratic compared to synthetic emulsifiers and its properties are naturally limited. Improvement in its properties is, therefore, in strong demand.

Furthermore, fluctuation in prices of gum arabic is great, depending on such factors as dry weather and unstable political situation in its chief producing districts including Sudan. In occasions its price jumps up to invite its undersupply. Under the circumstances, a number of proposals have been made for improving properties of gum arabic to enhance its emulsifying power and to reduce its amount of use as much as possible.

Exemplary proposals include a method for obtaining a modified gum arabic excelling in transparency and emulsifying power, which comprises a step of adjusting the water content of gum arabic to 3-30 wt % and a step of heating the same at temperatures not lower than 30° C. (cf. Patent Document 1); a method of modifying gum arabic by heating gum arabic to temperatures not lower than 40° C. in an atmosphere of 30-100% in relative humidity (cf. Patent Document 2); and a coenzyme Q10-containing emulsion composition for beverages in which desalted gum arabic is used, and a method for its preparation (cf. Patent Document 3).

Above-proposed methods, however, achieve only a limited extent of improvements in emulsifying power of gum arabic, or in stability or transparency of emulsified products, while giving rise to a serious defect of cost increase.

Those past proposals also include an emulsifier (e.g., octenylsuccinylated gum liquid) comprising a reaction product of at least one hydrocolloid having a viscosity of about 2-500 cP in 10% aqueous solution at 20° C., e.g., gum acacia (known as gum arabic) and about 2-15 wt %, based on the hydrocolloid, of at least one dicarboxylic acid anhydride selected from alkane- or alkene-substituted dicarboxylic acid anhydrides, e.g., octenylsuccinic acid anhydride; an oil-in-water emulsion comprising about 1-60% of at least one oil, about 0.5-30 wt % of above emulsifier, and water; and an oil-in-water emulsion in which at least about 60% of the oil droplets therein have particle diameters less than 2 (cf. Patent Documents 4 and 5).

While these proposals can produce emulsion-dispersed particles of an average particle size of 2 μm or less, they cannot produce a stable oil-in-water emulsion in which the average size of the particles dispersed therein is not more than 1 μm. Moreover, rapid demulsification of so obtained emulsion particles takes place after around 7 days of their preparation, and the emulsions are subject to the problem of instability.

There is a keen demand, therefore, to develop a novel substitute for gum arabic, having still higher emulsifying power while retaining desirable characteristics thereof, which would also contribute to cost reduction.

### PRIOR ART DOCUMENTS

### Patent Documents

Patent document 1: JP 2003-321502A

Patent document 2: WO 2003/093324A

Patent document 3: JP 2009-207384A

Patent document 4: JP 2004-532097T

Patent document 5: JP 2010-42412A

### SUMMARY OF THE INVENTION

### Problem to be Solved by the Invention

The object of the present invention is to provide an emulsified composition which is prepared using octenylsuccinic acid-modified gum arabic, whose particles are finer, more uniform and stable compared to those in conventional emulsions and which furthermore is easy of preparation; a method for preparing the same; and food and drink containing the same.

### Means for Solving the Problem

We have minutely investigated those past proposals as above, to come to conclude that a drastic improvement in emulsifying power of gum arabic could not be expected from simple physical modification or impartment of a new physical property, and to fix our eyes on chemical modification occasionally attempted with food additives. Thus we tried to modify gum arabic by a chemical modification method.

One of very widely used starting materials for foodstuff obtainable through chemical modification is chemically processed starch. Chemically processed starch is obtainable by various means of chemically modifying native starch produced from such starting materials as potato, corn, tapioca and wheat, and which is used for qualitative improvement or emulsification of foodstuff. Examples of chemically processed starch obtained through chemical modification include hydroxypropyl starch, carboxymethyl starch and cation starch obtained by etheification; octenylsuccinylated starch and phosphated starch obtained by esterification; diphosphated starch and glycerol starch formed by crosslinking; and grafted starch formed by grafting. Chemically processed starch has also generally been used for emulsifying food, but has the defect of retrogradation characteristic of starch, which gives rise to a qualitative problem that the emulsions prepared therewith or the food and drink to which the emulsions are added develop insoluble matters or precipitates when they are stored over a long period.

On the other hand, octenylsuccinic acid-modified gum arabic, which is a chemical modification product of gum arabic, can be used for preparing oil-in-water emulsions, similarly to gum arabic. Octenylsuccinic acid-modified gum arabic, however, has a low emulsifying power. For example, in an occasion of emulsifying an oil-soluble component such as orange oil with an aqueous solution of octenylsuccinic acid-modified gum arabic, the average particle diameter of the emulsion-dispersed particles cannot be made 1 μm or less. Moreover, demulsification of the resulting emulsion takes place and it is difficult to obtain therewith an emulsion stable over a long period.

We have made thorough studies about an additive component effective for stabilization of oil-in-water emulsions prepared with octenylsuccinic acid-modified gum arabic, and now come to discover that a combination of sucrose diacetate hexaisobutyrate (SAIB) and polyalcohol with octenylsuccinic acid-modified gum arabic gives emulsifying power about two to three times that of gum arabic; that octenylsuccinic acid-modified gum arabic as dissolved particularly in aqueous sorbitol solution enables to reduce the use amount of gum arabic to about ¼ or even less; that the combination enables very easy preparation of homogeneous emulsions containing edible oil ingredient such or orange oil, in which the emulsion-dispersed particles have an average particle diameter of 1 μm or less; and that, furthermore, the formed emulsified compositions are stable over a long period. The present invention is thus completed.

Accordingly, therefore, this invention provides an emulsified composition which is characterized by comprising

(A) edible oil material,

(B) sucrose diacetate hexaisobutyrate (SAIB),

(C) octenylsuccinic acid-modified gum arabic,

(D) polyalcohol,

and

(E) water.

The invention furthermore provides beverages in which the above emulsified composition is blended.

The invention also provides a method of preparing the emulsified composition, which comprises emulsifying and finely dispersing an oil phase comprising edible oil material (A) and sucrose diacetate hexaisobutyrate (SAIB) (B) in an aqueous phase comprising octenylsuccinic acid-modified gum arabic (C), in the presence of polyalcohol (D).

### Effect of the Invention

According to the invention, the concurrent use of sucrose diacetate hexaisobutyrate (SAIB) (B) and polyalcohol (D) with octenylsuccinic acid-modified gum arabic (C) as the emulsifier enables to obtain an emulsified composition in which the emulsion-dispersed particles are fine and uniform, using less amount of the emulsifier than that of gum arabic, which leads to cost reduction. Moreover, addition of the emulsified composition to food and drink enables to provide stable and high quality food and drink. Because the invention furthermore enables easy production of finely and homogeneously emulsified compositions without complex and costly emulsification facilities, it has a high industrial advantage that it makes production of emulsified goods possible, irrelevantly to the scales of production district or equipment investment.

### BRIEF EXPLANATION OF THE INVENTION

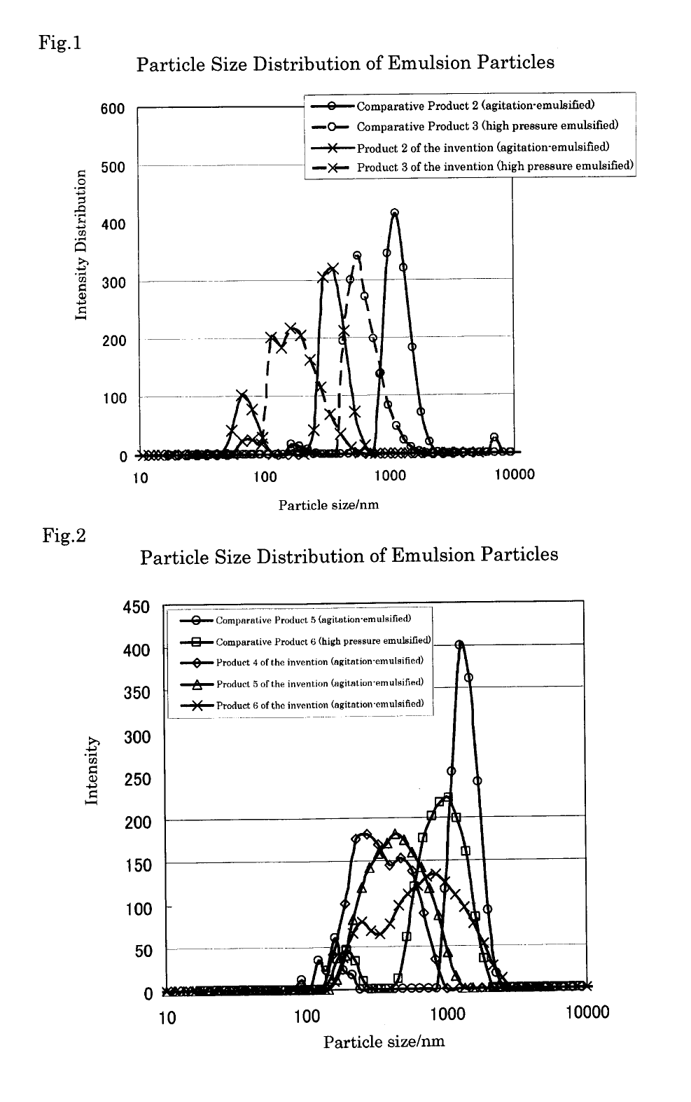

FIG. 1 shows the particle size distributions of Products 2 and 3 of the invention and those of Comparative Products 2 and 3.

FIG. 2 shows the particle size distributions of Products 4-7 of the invention and those of Comparative Products 5 and 6.

### EMBODIMENTS FOR WORKING THE INVENTION

Hereinafter the invention is explained in further details.

### (A) Edible Oil Materials:

Those edible oil materials (A) which can be emulsified according to the invention are subject to no particular limitation, examples of which include various fat and oil, oil-soluble pigments, fat-soluble vitamins, functional substances and flavor. The oil and fat include, for example, vegetable fat and oil such as soybean oil, rice oil, rice salad oil, sesame oil, peanut oil, corn oil, rapeseed oil, coconut oil and perm oil, and hardened oils thereof; animal fat and oil such as beef tallow, lard and chicken fat, and hardened oils thereof; and medium chain fatty acid triglyceride (MCT).

Examples of the oil-soluble pigment include oil-soluble natural pigments such as lycopene, tomato pigment, marigold pigment, Dunaliella carotene, carrot carotene, β-carotene, astaxanthin, paprika pigment, annatto pigment and chlorophyll. Those of the fat-soluble vitamins include cod-liver oil, vitamin A, vitamin A oil, vitamin D₃, vitamin B12 butyric acid ester, vitamin E, vitamin F and vitamin K. Examples of the functional substances include docosahexaenoic acid (DHA), eicosapentaenoic acid (EPA), DHA and/or EPA-containinig fish oil, lonoleic acid, γ-linolenic acid, α-linolenic acid, evening primrose oil, Borage oil, lecithin, octacosanol, rosemary extract, sage extract, γ-oryzanol, β-carotene, perm carotene and beefstake plant oil. Furthermore, examples of the flavor include natural essential oils, natural and synthesized flavors which are described in, for example, “Koryo Kagaku Soran”, 1, 2 and 3 (Osamu OKUDA, Hirokawa Publishers); “Gosei Koryo, Chemistry and Merchandise Information” (a revised and enlarged edition, Mar. 22, 2005, Motokazu INDO, Chemical Industry Daily News, Co.); and “Collection of Patent Publications, Known and Common Use Technologies (Flavor and Fragrance), Part 11, Flavor”, pp. 88-131, Jan. 14, 2000, The Japan Patent Office. More specifically, they include natural essential oils of citrus fruit such as orange, lemon, lime and grapefruit, flower essential oil, peppermint oil, spearmint oil and spice oil; natural flavor such as oleaginous extracts including cola nut extract, coffee extract, vanilla extract, cocoa extract, black tea extract, and spicery extracts, resinoid and oleoresins thereof; and at least one synthetic flavor selected from the group consisting of esters, alcohols, aldehydes, ketones, phenols, ethers, lactones, hydrocarbons, nitrogen- and/or sulfur-containing compounds and acids. These natural essential oils, natural flavor and synthetic flavor can be used either alone or in combination of two or more. Furthermore, the edible oil materials (A) can also be used alone or in combination of two or more.

The blend ratio of edible oil material (A) in the emulsified composition according to the invention, based on the mass of the emulsified composition, can be within a range of generally from 0.5 mass % to 50 mass %, preferably from 3 mass % to 40 mass %, inter alia, from 5 mass % to 35 mass %. Higher blend ratio of edible oil material (A) is preferred when transportation cost or storage space of the emulsified composition are considered, but when it is higher than 50 mass %, homogeneity of the emulsified composition is apt to become insufficient, which is undesirable. Also when the blend ratio of edible oil material (A) in the emulsified composition is less than 0.5 mass %, the amount of the emulsified composition for blending the required amount of edible oil material (A) with the end product increases, which is uneconomical.

### (B) Sucrose Diacetate Hexaisobutyrate (SAIB)

Sucrose diacetate hexaisobutyrate (SAIB) (B) used in the invention is blended for weighting the edible oil material (A) which forms the oil phase in the emulsified composition of the invention. It is subject to no particular limitation so long as it is of the quality suitable for use in foodstuff. SAIB on the market can be procured and used. Examples of useful SAIB (B) include those of the specific gravity within a range of from about 1.13 to about 1.19, preferably from about 1.14 to about 1.17, inter alia, from about 1.14 to about 1.15.

The content of SAIB (B) in the emulsified composition of the invention is variable depending on such factors as the specific gravity of used SAIB and that of the beverage into which the emulsified composition is blended, while it is desirable that the content be such that renders the difference between the specific gravity of the mixture of edible oil material (A) forming the oil phase in the emulsified composition of the invention with SAIB (B), and the specific gravity of the beverage into which the emulsified composition of the invention is blended, generally not more than 0.05, in particular, not more than 0.04, inter alia, not more than 0.03. Where the specific gravity difference exceeds 0.05, ring or oil float apt to take place in the beverage into which the emulsified composition of the invention is blended and which is stored over a long period.

The blend ratio of SAIB (B) in the emulsified composition of the invention can be normally within a range of from about 0.01 to about 5 mass parts, preferably from about 0.05 to about 3.5 mass parts, inter alia, from about 0.1 to about 2.5 mass parts, per 1 mass part of edible oil material (A). It is desirable, however, to empirically determine the ultimate blend ratio of SAIB (B) which renders the specific gravity difference between the beverage and the emulsified composition not more than 0.05, continuously measuring specific gravity of the beverage into which the emulsified composition of the invention is blended and that of the oil phase in the emulsified composition.

### (C) Octenylsuccinic Acid-Modified Gum Arabic:

The octenylsuccinic acid-modified gum arabic (OSGA) (C) which is used in the present invention is a food additive obtained by reacting gum arabic, the starting material, with octenylsuccinic acid anhydride, and is subject to no particular limitation so long as it qualifies as a food additive. For example, although not in limitative sense, those on market such as TICAMULSION A-2010, TICAMULSION A-2010-743 (TIC GUMS, Inc., USA) can be used.

The blend ratio of OSAG (C) in the emulsified composition of the invention, based on the mass of the emulsified composition, can be within a range of generally from 4 mass % to 24 mass %, preferably from 5 mass % to 20 mass %, inter alia, from 7.5 mass % to 12.5 mass %. Where the blend ratio of OSGA (C) is less than 4 mass %, the emulsion particles become greater and the particle diameters, non-uniform, leading to a possible failure in obtaining satisfactory emulsion particles. Also when the blend ratio of OSGA (C) exceeds 24 mass %, the emulsion particles become larger and non-uniform in size, being liable to provide unsatisfactory emulsion particles, which is undesirable.

OSGA (C) is usually in the form of powder which can be dissolved in water and used as an aqueous solution. The water used for this purpose is not critical and any of, e.g., tap water, distilled water, ion-exchange water or those which have been deaerated can be used.

The content of OSGA (C) in the aqueous OSGA (C) solution can be within a range of generally from 0.32 to 0.42 mass part, preferably from 0.33 to 0.40 mass part, inter alia, from 0.35 to 0.39 mass part, per 1 mass part of the OSGA (C) and water as combined. Where the content of OSGA (C) is less than 0.32, it becomes difficult to obtain fine and stable emulsion particles by emulsification of the oil phase with the aqueous OSGA solution, which is undesirable. Whereas, when the content of OSGA (C) exceeds the ratio of 0.42, the aqueous OSGA solution comes to have too high a viscosity, leading to a possibility that satisfactorily emulsified condition cannot be achieved in the occasion of mixing it with the oil phase to form an emulsion, which is undesirable.

The aqueous OSGA solution can serve as the aqueous phase for obtaining the emulsified composition of the present invention.

### (D) Polyalcohol:

The polyalcohol (D) useful in the present invention include preferably at least C₃, in particular, C₃-C₆, aliphatic or alicyclic hydrocarbon compounds having at least 2, in particular, 2-6, alcoholic hydroxyl groups per molecule, specific examples including alcohols such as propylene glycol and glycerin; and sugaralcohols such as sorbitol, maltitol, xylitol, erythritol and reducing thick malt syrup. These polyalcohols (D) can be used either alone or in combination of two or more. In particular, sorbitol, glycerin, or sorbitol and glycerin are preferred.

The blend ratio of polyalcohol (D) in the emulsified composition varies depending on such factors as the method of mixing OSGA into the composition and blend ratios of edible oil material (A) and SAIB (B), while it can be within a range of generally from 20 to 50 mass %, preferably from 25 to 45 mass %, inter alia, from 30 to 40 mass %, based on the mass of the emulsified composition.

Because polyalcohol (D) is water-soluble, it can be mixed into the composition by such methods as, for example: (i) mixing and dissolving polyalcohol (D) in the aqueous phase; (ii) mixing and dissolving polyalcohol (D) in a mixture of the aqueous phase and oil phase; or (iii) mixing and dissolving a part of the polyalcohol (D) in the aqueous phase, mixing the aqueous phase and oil phase, and thereafter mixing and dissolving the remaining polyalcohol (D) in the formed mixture. It has been confirmed that differences between these mixing methods affect the emulsifying performance of OSGA, more specifically, produce differences in its contribution to the emulsification condition such as formation of finer emulsion particles and their stabilization, or to reduction in use amount of OSGA.

Sugaralcohols such as sorbitol and maltitol are often marketed in the form of an aqueous solution in which the sugaralcohol is dissolved at a concentration around 70-75%, in consideration of its solubility at the time of use. Also for use in present invention, such an aqueous solution form is easy of dissolving in the aqueous phase and in consequence dispenses with the need of excessive agitation. Hence it is useful for preparation of the emulsified composition of high stability.

Of such polyalcohols (D), glycerin is preferably added to the system after the aqueous phase and oil phase are mixed and emulsified. It is known in general that the higher is the total blended amount of glycerin and other polyalcohol(s), the higher is its inhibitory effect on microbial proliferation. Where glycerin is used by itself, its microbial proliferation-inhibiting effect is expected when its blend ratio is 30% or higher. Thus, it is preferred to suitably set the polyalcohol (D) concentration according to the properties and kind of the food for which the composition is used.

### Emulsified Composition:

An emulsified composition of the present invention can be prepared by, in principle, emulsifying and finely dispersing the oil phase comprising edible oil material (A) and sucrose diacetate hexaisobutyrate (SAIB) (B) in the aqueous phase containing octenylsuccinic acid-modified gum arabic (C), in the presence of polyalcohol (D). Specifically, the composition can be prepared by, for example, the following methods:

(a) a method comprising mixing octenylsuccinic acid-modified gum arabic (C) with water to form an aqueous solution of the octenylsuccinic acid-modified gum arabic, mixing the aqueous solution with a mixture of edible oil material (A) and sucrose diacetate hexaisobutyrate (SAIB) (B), optionally conoducting an emulsifying and dispersing treatment, further mixing therewith polyalcohol (D), or polyalcohol (D) and water, and conducting an emulsifying and dispersing treatment;

(b) a method comprising mixing octenylsuccinic acid-modified gum arabic (C) with water to form an aqueous octenylsuccinic acid-modified gum arabic solution, mixing the aqueous solution with polyalcohol (D) to form an aqueous octenylsuccinic acid-modified gum arabic-poyalcohol solution, mixing the aqueous solution with a mixture of edible oil material (A) and sucrose diacetate hexaisobutyrate (SAIB) (B), optionally conoducting an emulsifying and dispersing treatment, further mixing therewith polyalcohol (D), or polyalcohol (D) and water, and conducting an emulsifying and dispersing treatment;

(c) a method comprising mixing polyalcohol (D) with water, mixing the resulting aqueous polyalcohol solution with octenylsuccinic acid-modified gum arabic (C) to form an aqueous octenylsuccinic acid-modified gum arabic-polyalcohol solution, mixing into the aqueous solution a mixture of edible oil material (A) and sucrose diacetate hexaisobutyrate (SAIB) (B), optionally conducting an emulsifying and dispersing treatment, further mixing therewith polyalcohol (D), or polyalcohol (D) and water, and conducting an emulsifying and dispersing treatment;

or

(d) a method comprising mixing sorbitol with water, mixing the resulting aqueous sorbitol solution with octenylsuccinic acid-modified gum arabic (C) to prepare an aqueous octenylsuccinic acid-modified gum arabic-sorbitol solution, adding to the aqueous solution a mixture of edible oil material (A) and sucrose diacetate hexaisobutyrate (SAIB) (B), optionally conducting an emulsifying and dispersing treatment, further mixing therewith sorbitol and/or glycerin, or sorbitol and/or glycerin and water, and conducting an emulsifying and dispersing treatment.

In the above methods, first edible oil material (A) and SAIB (B) are mixed to form the oil phase. Separately, an aqueous OSGA solution is prepared as the aqueous phase. Then the oil phase formed of the edible oil material (A) and SAIB (B), and the aqueous phase formed of the aqueous OSGA solution are given an emulsifying and dispersing treatment with an emulsifying device such as homo-mixer, colloid mill, high-pressure homogenizer or the like. Thereafter polyalcohol (D), e.g., glycerin and/or sorbitol, or a mixture of polyalcohol (D) and water is added to the system which is then further given an emulsifying and dispersing treatment with the emulsifying device. The emulsifying and dispersing treatment can be repeated until the particles dispersed in the emulsion attain the desired size. Whereby a homogeneous emulsified composition in which the emulsion-dispersed particles have an average particle diameter not more than 600 nm, preferably not more than 450 nm, inter alia, not more than 300 nm can be obtained.

The average size of emulsion particles can generally be measured with dynamic light-scattering particle size distribution meter or laser diffraction. One specific example of its measuring device is Electrophoresis Light-scattering Photometer ELS-8000 Model (Otsuka Electronics Co.).

An aqueous OSGA-polyalcohol solution obtained by mixing the whole or a part of polyalcohol (D) with an aqueous OSGA solution may also be used as the aqueous phase. As the polyalcohol (D), sorbitol is particularly preferred.

An aqueous OSGA-sorbitol solution can be prepared by, for example, a method comprising first mixing and dissolving sorbitol in water to form an aqueous sorbitol solution, and mixing and dissolving OSGA (C) in the aqueous solution. In that occasion, the mixing ratio of the water to the total amount of the sorbitol and water can be generally within a range of 0.45-0.60, preferably 0.50-0.55. Where the mixing ratio of water is less than 0.45, it becomes difficult to obtain fine and stable emulsion particles by emulsification of the oil phase with the aqueous OSGA-sorbitol solution, which is undesirable. Whereas, when the mixing ratio of water exceeds 0.60, the aqueous OSGA-sorbitol solution comes to have a viscosity too high to give favorable emulsion condition in the occasion of emulsifying the oil phase as mixed with the aqueous phase, which is undesirable.

The blend ratio of OSGA (C) to the aqueous sorbitol solution can be such that, per 1 mass part of the sum of sorbitol and water, OSGA (C) is within a range of generally from 0.045 to 0.30, preferably from 0.06 to 0.27, inter alia, from 0.08 to 0.25. Where the blend ratio of OSGA (C) is less than 0.045, it becomes difficult to obtain fine and stable emulsion particles by emulsification of the oil phase with the resulting aqueous OSGA-sorbitol solution, which is undesirable. Whereas, when the blend ratio of OSGA (C) exceeds 0.30, the resulting aqueous OSGA-sorbitol solution comes to have a viscosity too high to give favorable emulsion condition in the occasion of emulsifying the oil phase as mixed with the aqueous phase, which is undesirable.

The aqueous OSGA-sorbitol solution prepared as above is useful as the aqueous phase for obtaining the emulsified composition of the invention. It is also possible to add to an emulsion resulting from mixing and emulsifying such an aqueous phase with the oil phase, further sorbitol and/or glycerin, or sorbitol and/or glycerin and water, to dissolve the latter in the former.

The method comprising preparing an aqueous OSGA-sorbitol solution, mixing the solution serving as the aqueous phase with the oil phase and emulsifying the mixture has an advantage that it can reduce the use amount of OSGA (C) to about ¼-⅕ of that required in the method using an aqueous OSGA solution.

The blend ratio of the aqueous OSGA solution or aqueous OSGA-sorbitol solution in the emulsified composition according to the invention is not critical, but it can be within a range of, based on the mass of the emulsified composition, generally from about 20 to about 70 mass %, preferably from about 30 to about 65 mass %, inter alia, from about 45 to about 55 mass %.

The ratio, [(A)+(B)]/[(C)+(D)+(E)], of the sum of edible oil material (A) and sucrose diacetate hexaisobutyrate (SAIB) (B) (the oil phase) [(A)+(B)] to the sum of octenylsuccinic acid-modified gum arabic (C), polyalcohol (D) and water (E) (the aqueous phase) [(C)+(D)+(E)] is variable depending on the intended size of the emulsion particles and their stability in the emulsified composition. In general terms, however, the ratio can be within a range of from 0.005 to 0.55, preferably from 0.05 to 0.45, inter alia, from 0.125 to 0.35. Where the blend ratio is less than 0.005, concentration of edible oil material (A) in the resulting emulsified composition becomes too low to invite economical disadvantage. On the contrary, where it exceeds 0.55, there rises a problem of drop in the stability of the emulsion particles.

Emulsified compositions according to the invention may be blended with still other starting materials within a range not detrimental to the emulsification. Examples of such other components include water-soluble pigments; water-soluble vitamins; water-soluble antioxidants; flavor preservatives such as benzyl benzoate, triethyl citrate, diethyl phthalate, Hercolyn, medium chain fatty acid triglyceride and medium chain diglyceride; emulsifying agents other than those named, thickeners and stabilizers.

Emulsified compositions of the invention can be blended into various products, e.g., food and drink; cosmetics; health, hygienic and medicinal preparations; at the concentration levels ranging, e.g., around from 0.02 to 10 mass %, to impart and/or enhance favorable flavor, turbidity and/or color tone to, or of, these goods, or to facilitate taking of useful edible oil materials (A) by men, and to provide high quality and high value-added products.

### Beverage:

Those emulsified compositions provided by the invention excel in storage stability, and when blended in beverage, they can impart and/or enhance favorable flavor, turbidity and/or color tone. Examples of beverage in which an emulsified composition of the invention can be blended include acidic drink, fruit drink, carbonated drink and low-alcohol drink. Specific examples are those drink bases as used in Examples 4-6 given later, although not limited thereto so long as the difference in specific gravity between the drink and the oil phase of the emulsified composition is not more than 0.05.

Hereinafter the invention is more specifically explained referring to Examples, it being understood that the invention is not limited to these Examples only.

### EXAMPLES

### Example 1

### Preparation of an Aqueous OSGA Solution

A commercial OSGA, TICAMULSION (TIC Gums, Inc.) 1000 g was mixed with 50-55° C. refined water 1,700 g, sterilized by heating at 90-95° C. for 15 minutes, and cooled to no higher than 40° C. to provide an aqueous OSGA solution 2691 g (Product 1 of the invention).

### Comparative Example 1

### Preparation of an Aqueous Gum Arabic Solution

Example 1 was repeated except that gum arabic was used in place of OSGA, to provide an aqueous gum arabic solution 2588 g (Comparative Product 1).

### Example 2

### Preparation of Lemon Essential Oil Emulsion Using Product 1 of the Invention by Agitation

A medium chain fatty acid glycerin ester 83.1 g and SAIB 84.9 g were mixed and cooled, to which lemon essential oil 2 g was added to provide a weighted oil phase (weighted to make the difference in specific gravity from the beverage of Example 4 not more than 0.05).

To the aqueous OSGA solution (Product 1 of the invention) 480.0 g, the weighted oil phase was slowly added, emulsified at 8000 rpm for 15 minutes with TK-Homomixer (Tokushu Kika Kogyo Co.), and further mixed by agitation with a mixture of glycerin 310.0 g and sorbitol 100.0 g at 8000 rpm for 10 minutes with TK-Homomixer (Tokushu Kika Kogyo Co.) to provide an agitation-emulsified product 1060.0 g (Product 2 of the invention) having an average particle size ranging from 0.1 to 0.5 μm.

### Example 3

### Preparation of a High Pressure-Emulsified Product of Lemon Essential Oil Using Product 1 of the Invention

The agitation-emulsified product 500 g as obtained in Example 2 was transferred into a stainless steel vessel and treated 4 times with High Pressure Homogenizer (Gaulin Co.) at a homogenizing pressure of 40 MPa to provide a high pressure-emulsified product 495 g (Product 3 of the invention).

### Comparative Example 2

### Preparation of an Agitation-Emulsified Product of Lemon Essential Oil Using Comparative Product 1

Example 2 was repeated except that the aqueous gum arabic solution (Comparative Product 1) was used in place of the aqueous OSGA solution (Product 1 of the invention), to provide an agitation-emulsified product 1060.0 g (Comparative Product 2) having an average particle diameter ranging from 0.5 to 2 μm.

### Comparative Example 3

### Preparation of a High Pressure-Emulsified Product of Lemon Essential Oil Using Comparative Product 1

The agitation-emulsified product 500 g as obtained in Comparative Example 2 was transferred into a stainless steel vessel and treated 4 times with High Pressure Homogenizer (Gaulin Co.) at a homogenizing pressure of 40 MPa to provide a high pressure-emulsified product 493 g (Comparative Product 3).

### [Evaluation of Emulsified Products]

Products 2 and 3 of the invention and Comparative Products 2 and 3 were given an optical microscopic observation and measured of turbidity and average particle size. The results were as shown in the following Table 1. The measurements of average size and the size distribution of the emulsion-dispersed particles were made with Electrophoresis Light-scattering Photometer ELS-8000 Model (Otsuka Electronics Co.). The particle size distribution is shown in FIG. 1.

TABLE 1
Turbidity, Average Particle Size and Results of Optical
Microscopic Observation of Products 2 and 3 of the Invention and
Comparative Products 2 and 3

| | | | | Average | |
|---|---|---|---|---|---|
| | Emulsifying | Emulsifying | turbidity | Particle | Optical microscopic |
| | agent | method | (Abs.) | size (nm) | observation |
| Product 2 of | OSGA | agitation | 0.076 | 315 | Emulsion particles |
| the invention | | | | | were very fine. |
| Product 3 of | OSGA | high pressure | 0.031 | 283 | Emulsion particles |
| the invention | | homogenizing | | | were very fine. |
| Comparative | gum arabic | agitation | 0.276 | 1,074 | Emulsion particles |
| Product 2 | | | | | were coarse and not |
| | | | | | uniform-sized |
| | | | | | compared to those of |
| | | | | | products 2 and 3 of the |
| | | | | | invention. |
| Comparative | gum arabic | high pressure | 0.200 | 765 | Emulsion particles |
| Product 3 | | homogenizing | | | were fine but less fine |
| | | | | | than those of products |
| | | | | | 2 and 3 of the |
| | | | | | invention. |

As shown in Table 1, Products 2 and 3 of the invention prepared with use of OSGA had very fine emulsion-dispersed particles according to the optical microscopic observation. Average particle sizes of the emulsion-dispersed particles of Products 2 and 3 of the invention were, respectively, 315 nm and 283 nm, and turbidity levels were, respectively, 0.076 and 0.031.

Whereas, Comparative Product 2 prepared with use of gum arabic had the emulsion-dispersed particles larger than those of Products 2 and 3 of the invention, and their sizes were not uniform. The emulsion-dispersed particles in Comparative Product 3 were finer than those of Comparative Product 2, but larger than those of Products 2 and 3 of the invention. Comparative Products 2 and 3 had average particle sizes of, respectively, 1074 nm and 765 nm, and turbidity levels of, respectively, 0.276 and 0.200.

As above, in the emulsions in which OSGA was used according to the invention had the emulsion-dispersed particles having average particle sizes markedly reduced, to about ½ to ⅓ those of emulsions in which gum arabic was used, and the particles were uniform in sizes. That is, it was confirmed that very fine and uniform emulsion-dispersed particles were obtained, proving that OSGA has higher emulsifying power than gum arabic. Also due to the high emulsifying power, the emulsified compositions had very low turbidity and would be suitable as emulsions for which transparency is required.

### Comparative Example 4

### Preparation of Agitation-Emulsified Product of Lemon Essential Oil Using Polyglycerin Fatty Acid Ester

Medium chain fatty acid glycerin ester 98.5 g and SAIB 99.5 g were mixed and cooled, to which lemon essential oil 2.0 g was then added to provide a weighted oil phase. Polyglycerin fatty acid ester 40.0 g and glycerin 700.0 g were agitated and mixed with TK-Homomixer (Tokushu Kika Kogyo Co.), and the weighted oil phase was gradually added thereto and emulsified at 6000 rpm for 10 minutes. Then refined water 60.0 g was added and together agitated and mixed at 3000 rpm, to provide an agitation-emulsified product 1060.0 g (Comparative Product 4) having emulsion particles of from 0.1 to 0.5 μm in the average particle size.

### [Storage Test of the Emulsions]

Each of Product 2 of the invention and Comparative Products 3 and 4 was filled in a 15 ml-glass bottle up to the neck, and given a storage test each for a month as refrigerated, at ambient temperature or at 35° C. After the test the emulsions' turbidity and the average particle sizes of the emulsion-dispersed particles were measured. The results were as shown in the following Table 2.

TABLE 2
Storage Test Results of Product 2 of the invention
and Comparative Products 3 and 4

| | | | Immediately | After one-month storage | | |
|---|---|---|---|---|---|---|
| | Emulsifying | Turbidity | after | kept | ambient | |
| | agent | average particle size | preparation | refrigerated | temp. | 35° C. |
| Product 2 of | OSGA | turbidity (Abs.) | 0.079 | 0.089 | 0.085 | 0.088 |
| the invention | | average particle size | 329 | 331 | 374 | 403 |
| | | (nm) | | | | |
| Comparative | gum arabic | turbidity (Abs.) | 0.200 | 0.198 | 0.201 | 0.202 |
| Product 3 | | average particle size | 765 | 772 | 733 | 762 |
| | | (nm) | | | | |
| Comparative | polyglycerin | turbidity (Abs.) | 0.184 | 0.19 | 0.196 | 0.194 |
| Product 4 | fatty acid | average particle size | 381 | 438 | 425 | 452 |
| | ester | (nm) | | | | |

As is clear from the results shown in Table 2, the average particle size of Comparative Product 3 using gum arabic was 765 nm immediately after the preparation, which changed little after the one-month storage test under refrigeration, at ambient temperature and at 35° C. to, respectively, 772 nm, 733 nm and 762 nm. Turbidity also remained almost the same after the one-month storage test under refrigeration, at ambient temperature and at 35° C., i.e., 0.200 immediately after the preparation to, respectively, 0.198, 0.201 and 0.202. Thus, emulsification stability of the emulsions exhibited in the one-month storage test was good.

Product 2 of the invention using OSGA showed good emulsification stability in the one-month storage test, similarly to Comparative Product 3. Whereas, its average particle size immediately after the preparation was 329 nm, which changed little in the refrigeration storage to 331 nm but showed a certain increasing tendency after the storage at ambient temperature and 35° C. storage, i.e., to 374 nm and 403 nm, respectively.

Comparative Product 4 using polyglycerin fatty acid ester also showed good emulsification stability in the one-month storage test, similarly to Comparative Product 3. Whereas, its average particle size of 381 nm immediately after the preparation showed a certain increasing tendency after the storage under refrigeration, at embient temperature and at 35° C., to 438 nm, 425 nm and 452 nm, respectively.

### Example 4

### Stability Evaluation in Beverages

Product 2 of the invention and Comparative Products 3 and 4 were each added to a drink base (B×12°, pH 3.3) of the composition as shown in the following Table 3, at an odorizing ratio of 0.1% (W/W), filled in 200 ml-transparent juice bottle, sterilized (90-95° C., 15 minutes) and cooled to ambient temperature to provide the samples for storage test. The samples were kept refrigerated, at ambient temperature and at 35° C., respectively. The products' stability in the beverage samples was evaluated by examining formation of neck-ring, settlings or oil float with passage of time.

TABLE 3
Composition of Drink Base

| | Base-1 |
|---|---|
| Isomerized liquid sugar (B × 75°) | 157.0 g |
| Citric Acid | 1.5 g |
| Sodium citrate | 0.5 g |
| Vitamin C | 0.2 g |
| Refined water | 840.8 g |
| TOTAL | 1,000 g |

After one month passed, in none of Product 2 of the invention and Comparative Products 3 and 4, which were prepared with use of OSGA, gum arabic and polyglycerin fatty acid ester, respectively, neck-ring, settlement or oil float occurred, and the samples remained in good condition. Thus, the emulsified products are confirmed to be stable in the beverage using the above drink base.

### Example 5

### Stability Test in Fruit Drink

Product 2 of the invention and Comparative Products 3 and 4 were each added to a fruit drink base (B×12°, pH 3.3) of the composition as shown in the following Table 4, at an odorizing ratio of 0.1% (W/W), filled in a 200 ml-transparent juice bottle, sterilized (90-95° C. 15 minutes) and cooled to ambient temperature to provide the samples for storage test. The samples were kept refrigerated, at ambient temperature and at 35° C., respectively. Turbidity of the emulsified products and average size of the emulsion-dispersed particles were measured. The results were as shown in Table 5.

TABLE 4
Composition of Fruit Drink Base

| | Base-2 | |
|---|---|---|
| Isomerized liquid sugar (B × 75°) | 142.0 | g |
| Citric Acid | 1.5 | g |
| Sodium citrate | 0.5 | g |
| Vitamin C | 0.2 | g |
| Transparent conc. pineapple juice of (B × 61.8°) | 18.0 | g |
| Refined water | 837.8 | g |
| TOTAL | 1,000.0 | g |

TABLE 5
Stability Test of Product 2 of the invention and Comparative Products 3 and 4 in fruit drink

| | | | | | | After a week's storage | | |
|---|---|---|---|---|---|---|---|---|
| | Emulsifying | | | | | kept | Ambient | |
| | agent | | | Unsterilized | Sterilized | refrigerated | temp. | 35° C. |
| Product 2 of | OSGA | Base-1 | turbidity (Abs.) | 0.129 | 0.132 | 0.134 | 0.134 | 0.133 |
| the invention | | | Average Particle size | 349 | 331 | 327 | 344 | 337 |
| | | | (nm) | | | | | |
| | | Base-2 | turbidity (Abs.) | 0.138 | 0.136 | 0.137 | 0.135 | 0.138 |
| | | | Average Particle size | 347 | 313 | 326 | 330 | 306 |
| | | | (nm) | | | | | |
| Comparative | gum arabic | Base-1 | turbidity (Abs.) | 0.301 | 0.305 | 0.308 | 0.307 | 0.305 |
| Product 3 | | | Average Particle size | 615 | 647 | 603 | 628 | 633 |
| | | | (nm) | | | | | |
| | | Base-2 | turbidity (Abs.) | 0.316 | 0.315 | 0.32 | 0.315 | 0.31 |
| | | | Average Particle size | 562 | 564 | 562 | 565 | 594 |
| | | | (nm) | | | | | |
| Comparative | polyglycerin | Base-1 | turbidity (Abs.) | 0.279 | 0.277 | 0.282 | 0.284 | 0.279 |
| Product 4 | fatty acid | | Average Particle size | 410 | 419 | 408 | 422 | 415 |
| | ester | | (nm) | | | | | |
| | | Base-2 | turbidity (Abs.) | 0.509 | 0.615 | 0.579 | 0.569 | 0.531 |
| | | | | | | | | (flocs formed) |
| | | | Average Particle size | 1,495 | 1,619 | 1,142 | 1,391 | 1,864 |
| | | | (nm) | | | | | |

As is clear from the results shown in Table 5, Comparative Product 3 and Product 2 of the invention, which were prepared with use of gum arabic and OSGA, respectively, showed substantially no change in both turbidity and average particle size, with either base-1 or base-2, either before or after the sterilization or in any of refrigerated storage, storage at ambient temperature or at 35° C. Thus, the emulsion-dispersed particles are confirmed to be stable in the beverages.

On the other hand, Comparative Product 4 which was prepared with use of polyglycerin fatty acid ester showed almost no change in turbidity or average particle size when added to base-1, and stability of its emulsion-dispersed particles in the beverage was confirmed, but with base-2 it behaved quite differently. The turbidity markedly rose after the sterilization and the average particle size also increased. Moreover, after a week's storage at 35° C., the particles formed flocs and their average particle size notably increased.

Thus the emulsified products prepared with use of OSGA are confirmed to be useful also in fruit drinks.

### Example 6

### Stability Evaluation in Alcoholic Drinks

Product 2 of the invention and Comparative Products 3 and 4 were each added to alcoholic drink bases (bases 3-5: alcohol concentration, 21%, 28% and 35%, respectively) each having the composition as shown in Table 6, at an odorizing ratio of 0.1% (W/W) in terms of straight dilution ratio (alcohol concentration, 7%), filled in a 140 ml transparent mayonnaise bottle, to provide samples for the storage test. They were kept at ambient temperature for 3 days, and their appearance and liquid surfaces were observed, and the turbidity and average particle size at the dilution time to 7% alcohol concentration were measured to evaluate the samples' stability in the alcohol drinks. The results were as shown in Table 7.

TABLE 6
Composition of Alcohol drink bases

| | Base-3 | Base-4 | Base 5 |
|---|---|---|---|
| 99.5% ethanol | 210.0 ml | 280.0 ml | 350.0 ml |
| Isomerized liquid | 90.0 g | 120.0 g | 150.0 g |
| sugar (B × 75°) | | | |
| Citric Acid | 8.7 g | 11.6 g | 14.5 g |
| Sodium citrate | 1.2 g | 1.6 g | 2.0 g |
| Refined water | balance | balance | balance |
| TOTAL | 1,000.0 g | 1,000.0 g | 1,000.0 g |

TABLE 7
Storage Test of Stability in Alcohol Drinks of Product 2 of the Invention and Comparative Products 3 and 4.

| | | | Base-3 | | | | |
|---|---|---|---|---|---|---|---|
| | | | | Average | Appearance | Base-4 | |
| | | | | Particle | and Liquid | | Average |
| | | Number of | turbidity | size | Surface | | Particle size |
| | Emulsifier | days stored | (Abs.) | (nm) | Observation | turbidity (Abs.) | (nm) |
| Product 2 | OSGA | Immediately | 0.157 | 325 | Oil film (++) | 0.164 | 355 |
| of the | | after | | | | | |
| invention | | odorizing | | | | | |
| | | 1 day | 0.169 | 354 | Oil film (++) | 0.208 | 375 |
| | | 2 days | 0.175 | 322 | Oil film (++) | 0.229 | 383 |
| | | 3 days | 0.179 | 345 | Oil film (++) | 0.245 | 484 |
| Comparative | gum arabic | Immediately | 0.354 | 614 | Oil film (+) | 0.332 | 669 |
| Product 3 | | after | | | | | |
| | | odorizing | | | | | |
| | | 1 day | 0.358 | 648 | Oil film (+) | 0.376 | 700 |
| | | 2 days | 0.356 | 560 | Oil film (+) | 0.386 | 604 |
| | | 3 days | 0.361 | 662 | Oil film (+) | 0.393 | 721 |
| Comparative | Poly- | Immediately | 0.333 | 424 | No | 0.336 | 438 |
| Product 4 | glycerin | after | | | abnormality | | |
| | fatty acid | odorizing | | | (−) | | |
| | ester | 1 day | 0.334 | 436 | No | unmeasurable | unmeasurable |
| | | | | | abnormality | | |
| | | | | | (−) | | |
| | | 2 days | 0.337 | 387 | No | unmeasurable | unmeasurable |
| | | | | | abnormality | | |
| | | | | | (−) | | |
| | | 3 days | 0.338 | 451 | No | unmeasurable | unmeasurable |
| | | | | | abnormality | | |
| | | | | | (−) | | |

| | | | Base-4 | Base-5 | | |
|---|---|---|---|---|---|---|
| | | | Appearance | | | Appearance |
| | | | and Liquid | | Average | and Liquid |
| | | Number of | Surface | | Particle size | Surface |
| | Emulsifier | days stored | Observation | turbidity (Abs.) | (nm) | Observation |
| Product 2 | OSGA | Immediately | Oil film (++) | 0.222 | 506 | Oil film (++) |
| of the | | after | | | | |
| invention | | odorizing | | | | |
| | | 1 day | Oil film (++) | 0.387 | 666 | Oil film (++) |
| | | 2 days | Oil film (++) | 0.455 | 669 | Oil film (++) |
| | | 3 days | Oil film (++) | 0.499 | 729 | Oil film (++) |
| Comparative | gum arabic | Immediately | Oil film (+) | 0.437 | 790 | Oil film (+) |
| Product 3 | | after | | | | |
| | | odorizing | | | | |
| | | 1 day | Oil film (+) | 0.547 | 912 | Oil film (+) |
| | | 2 days | Oil film (+) | 0.548 | 738 | Oil film (+) |
| | | 3 days | Oil film (+) | 0.604 | 927 | Oil film (+) |
| Comparative | Poly- | Immediately | No | unmeasurable | unmeasurable | oil droplets |
| Product 4 | glycerin | after | abnormality | | | and flocs |
| | fatty acid | odorizing | (−) | | | (+++) |
| | ester | 1 day | oil droplets | unmeasurable | unmeasurable | oil droplets |
| | | | and flocs | | | and flocs |
| | | | (+++) | | | (++++) |
| | | 2 days | oil droplets | unmeasurable | unmeasurable | oil droplets |
| | | | and flocs | | | and flocs |
| | | | (+++) | | | (++++) |
| | | 3 days | oil droplets | unmeasurable | unmeasurable | oil droplets |
| | | | and flocs | | | and flocs |
| | | | (+++) | | | (++++) |

As is clear from Table 7, formation of a very small amount of oil film was observed in all of the bases 3-5 to which Comparative Product 3 prepared with use of gum arabic had been added, immediately after the odorizing or during the following 3 days' storage, but no notable demulsification or occurrence of insoluble matter was perceived, and the product remained in good emulsion condition.

Similarly to Comparative Product 3, Product 2 of the invention prepared with use of OSGA caused no notable demulsification or formation of insoluble matter in all of the bases, and retained the good emulsion condition. However, when compared with Comparative Product 3, the oil film on the base liquid surfaces was slightly more and it tended to show a slightly higher turbidity variation.

Whereas, Comparative Product 4 prepared with use of polyglycerin fatty acid ester retained good emulsion condition in base-3 and developed no abnormality after 3 days' storage, but occurrence of notable oil droplets and insoluble matter (flocs) was observed after one day in base-4, and immediately after odorizing, in base-5. That is, the emulsified product was confirmed to be stable up to 21% alcohol concentration, but to become unstable at higher alcohol concentration.

Summarizing the above results, Product 2 of the invention prepared with use of OSGA is useful in high-alcohol drinks, although it is slightly less stable when compared with Comparative Product 3 prepared with use of gum arabic.

### Example 7

### Preparation of Agitation-Emulsified Product of Grapefruit Essential Oil (Product 4 of the Invention)

Tocopherol extract 1.0 g, medium chain fatty acid glycerin ester 73.5 g and SAIB 70.5 g were mixed, cooled, and to which grapefruit essential oil 25.0 g was added to provide a weighted oil phase. The weighted oil phase was gradually added to the aqueous OSGA solution (Product 1 of the invention) 550.0 g and together emulsified with TK-Homomixer (Tokushu Kika Kogyo Co.) at 8,000 rpm for 15 minutes. Thereafter a mixture of glycerin 300.0 g and sorbitol 50.0 g was added to the system, followed by further agitation-mixing treatment with TK-Homomixer (Tokushu Kika Kogyo Co.) at 8,000 rpm for 10 minutes, to provide an agitation-emulsified product (Product 4 of the invention) 1070.0 g in which the average size of emulsion-dispersed particles was from 0.1 to 0.5 μm.

### Example 8

### Preparation of Agitation-Emulsified Product of Grapefruit Essential Oil (Product 5 of the Invention)

Example 7 was repeated except that instead of the aqueous OSGA solution (Product 1 of the invention) 550.0 g, a mixture of the aqueous OSGA solution (Product 1 of the invention) 280.0 g with glycerin 270.0 g was used as the aqueous phase, to provide an emulsified product (Product 5 of the invention) 1070.0 g in which the average size of emulsion-dispersed particles was from 0.5 to 1.0 μm.

### Example 9

### Preparation of Agitation-Emulsified Product of Grapefruit Essential Oil (Product 6 of the Invention)

Example 7 was repeated except that instead of the aqueous OSGA solution (Product 1 of the invention) 550.0 g, a mixture of the aqueous OSGA solution (Product 1 of the invention) 210.0 g with glycerin 340.0 g was used as the aqueous phase, to provide an emulsified product (Product 6 of the invention) 1070.0 g in which the average size of emulsion-dispersed particles was from 1.0 to 2.0 μm.

### Example 10

### Preparation of Agitation-Emulsified Product of Grapefruit Essential Oil (Product 7 of the Invention)

Example 7 was repeated except that instead of the aqueous OSGA solution (Product 1 of the invention) 550.0 g, a mixture of the aqueous OSGA solution (Product 1 of the invention) 140.0 g with glycerin 410.0 g was used as the aqueous phase, to provide an emulsified product (Product 7 of the invention) 1070.0 g in which the average size of emulsion-dispersed particles was from 1.0 to 2.0 μm.

### Comparative Example 5

### Preparation of Agitation-Emulsified Product of Grapefruit Essential Oil (Comparative Product 5)

Example 7 was repeated except that the aqueous gum arabic solution (Comparative Product 1) was used in place of the aqueous OSGA solution (Product 1 of the invention), to provide an emulsified product (Comparative Product 5) 1070.0 g in which the average size of emulsion-dispersed particles was from 0.5 to 1.0

### Comparative Example 6

### Preparation of High-Pressure Emulsified Product of Grapefruit Essential Oil (Comparative Product 6)

The agitation-emulsified product 500 g as obtained in Comparative Example 5 was transferred into a stainless steel vessel and treated 4 times with High Pressure Homogenizer (Gaulin Co.) at a homogenizing pressure of 40 MPa to provide a high pressure-emulsified product 493 g (Comparative Product 6).

### [Evaluation of Emulsified Products]

Products 4-7 of the invention and Comparative Products 5 and 6 were given an optical microscopic observation and measured of turbidity and average particle size. The results were as shown in the following Table 8. The measurements of average size and the size distribution of the emulsion-dispersed particles were made with Electrophoresis Light-scattering Photometer ELS-8000 Model (Otsuka Electronics Co.). The particle size distribution is shown in FIG. 2.

TABLE 8
Turbidity, Average Particle Size and Results of Optical Microscopic
Observation of Products 4-7 of the Invention and Comparative Products 5 and 6

| | | | | Average | |
|---|---|---|---|---|---|
| | Emulsifying | Emulsifying | turbidity | particle size | |
| | agent | method | (Abs.) | (nm) | Optical microscopic observation |
| Product 4 of | OSGA | agitation | 0.094 | 286 | Very fine emulsion particles. |
| the invention | | | | | |
| Product 5 of | OSGA | agitation | 0.139 | 434 | Very fine emulsion particles, though slightly less |
| the invention | | | | | fine than those of product 4 of the invention. |
| Product 6 of | OSGA | agitation | 0.187 | 512 | Fine emulsion particles, though slightly less fine |
| the invention | | | | | than those of product 4 or 5 of the invention. |
| Product 7 of | OSGA | agitation | 0.221 | 598 | Emulsion particles were fine but not uniform in size |
| the invention | | | | | and many unemulsified particles remained. |
| Comparative | gum arabic | agitation | 0.288 | 1003 | Emulsion particles were slightly larger than those |
| Product 5 | | | | | of products 4 and 5 of the invention, and were |
| | | | | | markedly varied in size. |
| Comparative | gum arabic | High pressure | 0.203 | 793 | Emulsion particles were fine but less fine than |
| Product 6 | | homogenizing | | | those of products 4 or 5 of the invention. |

As is clear from Table 8, all of Products 4-7 prepared with use of OSGA had less average particle sizes than those of Comparative Products 4 and 5 prepared with use of gum arabic, and had lower turbidity. In particular, although Products 4 and 5 of the invention were prepared by agitation emulsification, they had attained extremely fine emulsion particles in comparison with Comparative Product 6 which was a high pressure emulsified product prepared with use of gum arabic, and also had low turbidity. Product 6 of the invention was of fine emulsion particles, although slightly less fine than those of Products 4 and 5 of the invention. The emulsion particles of Product 7 of the invention were fine but not uniform in size and many unemulsified particles were perceived.

From the results as above, it is confirmed that gum arabic cannot give emulsion particles of small average size by agitation emulsification only, and requires additional use of a high pressure homogenizer, but OSGA can provide low turbidity emulsions of fine emulsion particles by agitation emulsification only, proving high emulsifying power of OSGA.

Again, OSGA enables to substantially reduce its use rate compared to gum arabic, and has the advantage of achieving cost reduction.

### Example 11

### Preparation of Lemon Essential Oil-Blended Emulsion Using Aqueous OSGA Solution

TICAMULSION (TIC Gums, Inc.) available on the market 185 g was mixed and dissolved in water (soft water) 315 g at 50-55° C., sterilized by heating at 90-95° C. for 15 minutes, and cooled to 40° C. or lower to provide a 37% aqueous OSGA solution (Product 1 of the invention).

Tocopherol extract 1 g, MCT 47.1 g and SAIB 76.9 g were mixed at 90-95° C., cooled to 30-40° C., and to which lemon essential oil 25 g was added to provide a weighted oil phase 150 g. This weighted oil phase was gradually added into the 37% aqueous OSGA solution, emulsified with TK-Homomixer (Tokushu Kika Kogyo Co.) at 7,000-8,000 rpm for 15 minutes. Thereafter a mixture of glycerin 300 g and 70% aqueous sorbitol solution 50 g was added to the resulting emulsion and given a further agitation and mixing treatment with TK-Homomixer (Tokushu Kika Kogyo Co.) at 3,000 rpm for 10 minutes, to provide a lemon essential oil-blended emulsion (Product 8 of the invention).

### Example 12

### Preparation of Lemon Essential Oil-Blended Emulsion Using 10% Aqueous OSGA-Sorbitol Solution

TICAMULSION (TIC Gums, Inc.) available on the market 50 g was mixed and dissolved in 70% aqueous sorbitol solution 450 g at 50-55° C., sterilized by heating at 90-95° C. for 15 minutes, and cooled to 40° C. or lower to provide a 10% aqueous OSGA-sorbitol solution (Product 9 of the invention). The aqueous solution was mixed with 50% aqueous lactic acid solution 50 g as a pH-regulating agent.

Tocopherol extract 1 g, MCT 47.1 g and SAIB 76.9 g were mixed at 90-95° C., cooled to 30-40° C., and to which lemon essential oil 25 g was added to provide a weighted oil phase 150 g. This weighted oil phase was gradually added into the 10% aqueous OSGA-sorbitol solution (Product 9 of the invention), emulsified with TK-Homomixer (Tokushu Kika Kogyo Co.) at 7,000-8,000 rpm for 15 minutes. Thereafter a mixture of glycerin 250 g and water 50 g was added to the resulting emulsion and given a further agitation and mixing treatment with TK-Homomixer (Tokushu Kika Kogyo Co.) at 3,000 rpm for 10 minutes, to provide a lemon essential oil-blended emulsion (Product 10 of the invention.

### Example 13

### Preparation of Lemon Essential Oil-Blended Emulsion Using 10% Aqueous OSGA-Sorbitol Solution

Example 12 was repeated except that the amount of glycerin in Product 10 of the invention was reduced by 50 g and that of the oil phase was increased by 50 g, all other composition being the same as shown in Table 9, to provide a lemon essential oil-blended emulsion (Product 11 of the invention).

### Comparative Example 7

### Preparation of Lemon Essential Oil-Blended Emulsion Using 37% Aqueous Gum Arabic Solution

Example 11 was repeated except that 37% aqueous gum arabic solution 500 g was used in place of the 37% aqueous OSGA solution 500 g, to provide a lemon essential oil-blended emulsion (Comparative Product 7).

### Comparative Example 8

### Preparation of Lemon Essential Oil-Blended Emulsion Using 37% Aqueous Gum Arabic Solution

The lemon essential oil-blended emulsion (Comparative Product 7) as obtained in Comparative Example 7 was treated with a high pressure homogenizer (Gaulin Co.) at a homogenizing pressure of 40 MPa 4 times to provide a high pressure-homogenized emulsion (Comparative Product 8).

TABLE 9
Composition of Lemon Essential Oil-Blended Emulsions

| | | Product 8 | Product 10 | Product 11 | Comparative |
|---|---|---|---|---|---|
| | | of the | of the | of the | Products 7 |
| | | invention | invention | invention | and 8 |
| Aqueous | OSGA | 185 | 50 | 50 | |
| phase | gum | | | | 185 |
| | arabic | | | | |
| | water | 315 | | | 315 |
| | 70% | | 450 | 450 | |
| | aqueous | | | | |
| | sorbitol | | | | |
| | solution | | | | |
| | 50% | | 50 | 50 | |
| | aqueous | | | | |
| | lactic acid | | | | |
| | solution | | | | |
| Oil phase | MCT | 47.1 | 47.1 | 73.9 | 47.1 |
| | SAIB | 76.9 | 76.9 | 100.1 | 76.9 |
| | Vitamin E | 1 | 1 | 1 | 1 |
| | lemon | 25 | 25 | 25 | 25 |
| | essential | | | | |
| | oil | | | | |
| Stabilizer | water | | 50 | 50 | |
| | 70% | 50 | | | 50 |
| | aqueous | | | | |
| | sorbitol | | | | |
| | solution | | | | |
| | glycerin | 300 | 250 | 200 | 300 |
| | TOTAL | 1000 | 1000 | 1000 | 1000 |

### [Evaluation of the Emulsions]

Those lemon essential oil-blended emulsions of Products 8 and 10-11 of the invention and Comparative Products 7 and 8 were given an optical microscopic observation and measured of turbidity and average particle size. The results were as shown in Table 10. The measurements of average size and the size distribution of the emulsion-dispersed particles were made with Electrophoresis Light-scattering Photometer ELS-8000 Model (Otsuka Electronics Co.).

TABLE 10
Turbidity, Average Particle Size and Results of Optical Microscopic Observation of
Products 8, 10, 11 of the Invention and Comparative Products 7 and 8

| | | | turbidity | Average | | |
|---|---|---|---|---|---|---|
| | | | (Abs.) | Particle | | |
| | Emulsifying | | (1/2000H₂O, | size | | |
| | agent | Emulsifying method | 680 nm) | (nm) | Optical microscopic observation | Evaluation |
| Product 8 of | OSGA | agitation-emulsified | 0.075 | 329 | Unemulsified particles remained | ◯ |
| the invention | | | | | but emulsion particles were fine. | |
| Product 10 of | OSGA | agitation-emulsified | 0.112 | 372 | Emulsion particles were very fine, | ⊙ |
| the invention | | | | | and more uniform-sized than | |
| | | | | | those of product 8 of the | |
| | | | | | invention. | |
| Product 11 of | OSGA | agitation-emulsified | 0.16 | 414 | Emulsion particles were very fine, | ⊙ |
| the invention | | | | | and more uniform-sized than | |
| | | | | | those of product 8 of the | |
| | | | | | invention. | |
| Comparative | gum arabic | agitation-emulsified | 0.21 | 1,250 | Emulsion particles were coarse | X |
| Product 7 | | | | | and not uniform, emulsified | |
| | | | | | condition poor. | |
| Comparative | gum arabic | high pressure-emulsified | 0.146 | 841 | Emulsion particles were fine but | ⊙ |
| Product 8 | | | | | less fine than those of products 10 | |
| | | | | | and 11 of the invention. | |

As shown in Table 10, in Product 8 of the invention which was prepared with use of 37% aqueous OSGA solution (Product 1 of the invention), the emulsion particles were fine, though unemulsified particles remained. By contrast, the emulsion particles of Products 10 and 11 of the invention using 10% aqueous OSGA-sorbitol solution (Product 9 of the invention) were very fine, and more uniform and favorable than Product 8 of the invention. Although an increased amount of the oil phase was used in Product 11, still very uniform and favorable emulsion particles were obtained.

Whereas, Comparable Product 7, which was prepared with 37% aqueous gum arabic solution, was in poorly emulsified condition, the particles therein being coarse and irregular-sized. For making them uniform and favorable emulsion particles, high-pressure emulsification was necessary.

From the above results, it was confirmed that the use of the 10% aqueous OSGA-sorbitol solution (Product 9 of the invention) rather than the 37% aqueous OSGA solution (Product 1 of the invention) rendered the emulsion particles very fine and uniform to produce excellent emulsion condition, although the amount of OSGA serving as the emulsifier was reduced to about ¼. Moreover, the favorably emulsified product was obtained by simpler emulsifying treatment, than the case of using the 37% aqueous gum arabic solution.

Accordingly, the emulsifying method using 10% aqueous OSGA-sorbitol solution (Product 9 of the invention) is markedly advantageous in respect of cost effectiveness and rationalization of the production, and is expected to further expand the possibility for utilization of the resultant emulsified products.

### [Storage Test of the Emulsions]

Those lemon essential oil-blended emulsions of Products 8 and 10-11 of the invention and Comparative Product 8 were each filled in a 15-ml glass bottle to the full, and stored under refrigeration and at ambient temperature, 35° C. and 50° C., respectively, to be observed of their changes with time. The results were as shown in Table 11.

TABLE 11
Storage Test Results of Lemon Essential Oil-blended Emulsions

| | | Turbidity and | Immediately | After 6 months storage | | | |
|---|---|---|---|---|---|---|---|
| | | average particle | after | under | | | |
| | emulsifier | size | preparation | refrigeration | ambient temp. | 35° C. | 50° C. |
| Product 8 of | OSGA | turbidity (abs.) | 0.075 | 0.112 | 0.142 | 0.192 | (phase |
| the | | average particle | 329 | 410 | 482 | 538 | separation) |
| invention | | size (nm) | | | | | |
| Product 10 | OSGA | turbidity (abs.) | 0.012 | 0.117 | 0.133 | 0.138 | 0.179 |
| of the | | average particle | 372 | 365 | 420 | 451 | 502 |
| invention | | size (nm) | | | | | |
| Product 11 | OSGA | turbidity (abs.) | 0.16 | 0.166 | 0.180 | 0.198 | 0.220 |
| of the | | average particle | 414 | 387 | 422 | 420 | 580 |
| invention | | size (nm) | | | | | |
| Comparative | gum arabic | turbidity (abs.) | 0.146 | 0.15 | 0.154 | 0.170 | 0.183 |
| Product 8 | | average particle | 841 | 832 | 879 | 890 | 912 |
| | | size (nm) | | | | | |

As shown in Table 11, separation was observed in Product 8 of the invention when stored at 50° C., however, during the refrigerated, ambient temperature or 35° C. storage, no separation occurred and the emulsion was stable, although its turbidity and average particle size tended to increase.

Compared to Product 8 of the invention, Products 10 and 11 of the invention showed less turbidity change and average particle size change, and the emulsions were very stable and favorable.

By contrast, Comparative Product 8 maintained stably emulsified condition but its particles were coarse, as evidenced by their average particle size of 841 nm immediately after preparation.

### Example 14

### Preparation of Carotene-Blended Emulsions Using 10% Aqueous OSGA-Sorbitol Solution

TICAMULSION (TIC Gums, Inc.) available on the market 50 g was mixed and dissolved in 70% aqueous sorbitol solution 450 g at 50-55° C., sterilized by heating at 90-95° C. for 15 minutes, and cooled to 40° C. or lower to provide a 10% aqueous OSGA-sorbitol solution (Product 9 of the invention).

Crystallin β-carotene 12.5 g, tocophenol extract 1 g, MCT 52.8 g, SAIB 73.7 g and limonene 10 g were together heated and melted, which was cooled to 90-100° C. to provide a weighted oil phase. The weighted oil phase was gradually added to the aqueous phase formed by mixing the 10% aqueous OSGA-sorbitol solution (Product 9 of the invention) with 50% aqueus lactic acid solution 50 g, and emulsified with TK-Homomixer (Tokushu Kika Kogyo Co.) at 7,000-8,000 rpm for 15 minutes. Thereafter a mixture of glycerin 250 g and a 70% aqueous sorbitol solution 50 g was added, followed by further agitation-mixing with TK-Homomixer (Tokushu Kika Kogyo Co.) at 7,000-8,000 rpm for 10 minutes, to provide a carotene emulsion (Product 12 of the invention).

### Example 15

### Preparation of Carotene-Blended Emulsions Using 10% Aqueous OSGA-Sorbitol Solution

Example 14 was repeated except that the oil phase and stabilizer were replaced with those shown in Table 12, to provide carotene emulsions (Products 12-14 of the invention).

### Comparative Example 9

### Preparation of Carotene-Blended Emulsions Using Comparative Product 1-1

Example 14 was repeated except that the aqueous phase formed by mixing 10% aqueous OSGA-sorbitol solution with 50% aqueous lactic acid solution was replaced with 37% aqueous gum arabic solution, to provide carotene emulsions (Comparative Products 9 and 10).

TABLE 12
Composition of β-carotene-blended Emulsions

| | | Product | Product | Product | | |
|---|---|---|---|---|---|---|
| | | 12 of the | 13 of the | 14 of the | Comparative | Comparative |
| | | invention | invention | invention | Product 9 | Product 10 |
| Aqueous | OSGA | 50 | 60 | 60 | | |
| phase | gum arabic | | | | 185 | 185 |
| | water | | | | 315 | 315 |
| | 70% | 450 | 540 | 540 | | |
| | aqueous | | | | | |
| | sorbitol | | | | | |
| | solution | | | | | |
| | 50% | 50 | 50 | 50 | | |
| | aqueous | | | | | |
| | lactic acid | | | | | |
| | solution | | | | | |
| Oil phase | MCT | 52.8 | 76.2 | 104.1 | 52.8 | 50.7 |
| | SAIB | 73.7 | 123.8 | 145.9 | 73.7 | 99.3 |
| | Vitamin E | 1 | 5 | 5 | 1 | 5 |
| | β-carotene | 12.5 | 25 | 25 | 12.5 | 25 |
| | limonene | 10 | 20 | 20 | 10 | 20 |
| Stabilizer | 70% | 50 | 50 | 50 | 50 | 50 |
| | aqueous | | | | | |
| | sorbitol | | | | | |
| | solution | | | | | |
| | glycerin | 250 | 50 | | 300 | 250 |
| | Total | 1000 | 1000 | 1000 | 1000 | 1000 |

### [Evaluation of Emulsions]

Those carotene-blended emulsions of Products 12-14 of the invention and Comparative Products 9-10 were given an optical microscopic observation and measured of turbidity and average particle size. The results were as shown in Table 13. The measurements of average size and the size distribution of the emulsion-dispersed particles were made with Electrophoresis Light-scattering Photometer ELS-8000 Model (Otsuka Electronics Co.).

TABLE 13
Turbidity, Average Particle Size and Results of Optical Microscopic Observation of
Products 12-14 of the Invention and Comparative Products 9 and 10

| | | | turbidity | Average | | |
|---|---|---|---|---|---|---|
| | | | (Abs). | Particle | | |
| | Emulsifying | | (1/2000H₂O, | size | | |
| | agent | Emulsifying method | 680 nm) | (nm) | Optical microscopic observation | Evaluation |
| Product 12 of | OSGA | agitation-emulsified | 0.192 | 384 | Very fine emulsion particles, no | ⊙ |
| the invention | | | | | crystalline carotene precipitation. | |
| Product 13 of | OSGA | agitation-emulsified | 0.465 | 413 | Very fine emulsion particles, no | ⊙ |
| the invention | | | | | crystalline carotene precipitation. | |
| Product 14 of | OSGA | agitation-emulsified | 0.630 | 526 | Very fine emulsion particles, no | ⊙ |
| the invention | | | | | crystalline carotene precipitation. | |
| Comparative | gum arabic | agitation-emulsified | (not | (not | Emulsion particles not finely | X |
| Product 9 | | | measured) | measured) | divided, carotene precipitation | |
| | | | | | observed. | |
| Comparative | gum arabic | agitation-emulsified | (not | (not | Emulsion particles not finely | X |
| Product 10 | | | measured) | measured) | divided, carotene precipitation | |
| | | | | | observed. | |

As shown in Table 13, in Products 12, 13 and 14 which were prepared using the 10% aqueous OSGA-sorbitol solution, the emulsion particles were very fine.

By contrast, Comparative Products 9 and 10 which were prepared with use of 37% aqueous gum arabic solution could not attain fine particulation of the particles and showed precipitation of crystalline carotene. Their emulsified condition was poor.

From the above results, it is confirmed, while use of 37% aqueous gum arabic solution resulted in precipitation of crystalline carotene and poor emulsification, that 10% aqueous OSGA-sorbitol solution (Product 9 of the invention) could produce favorable emulsions and, furthermore, the amount of added OSGA could be as little as only 5-6% of the whole emulsion.

Thus, emulsification of carotene using the 10% aqueous OSGA-sorbitol solution is highly advantageous in respect of cost, and OSGA is found to have excellent properties as an emulsifier.

### [Stability Test of the Emulsions]

Those carotene-blended emulsions of Products 12, 13 and 14 of the invention were each filled in a 15-ml glass bottle to the full, and stored under refrigeration and at ambient temperature, 35° C. and 50° C., respectively, to be observed of their changes with time. The results were as shown in Table 14.

TABLE 14
Storage Test Results of Carotene-blended Emulsions

| | | Turbidity and | Immediately | After 6 months storage | | | |
|---|---|---|---|---|---|---|---|
| | | average particle | after | under | ambient | | |
| | emulsifier | size | preparation | refrigeration | temp. | 35° C. | 50° C. |
| Product 12 | OSGA | turbidity (abs.) | 0.192 | 0.196 | 0.199 | 0.208 | (phase separation) |
| of the | | average particle | 384 | 374 | 384 | 398 | |
| invention | | size (nm) | | | | | |
| Product 13 | OSGA | turbidity (abs.) | 0.465 | 0.469 | 0.472 | 0.490 | (phase separation) |
| of the | | average particle | 413 | 423 | 425 | 471 | |
| invention | | size (nm) | | | | | |
| Product 14 | OSGA | turbidity (abs.) | 0.630 | 0.632 | 0.642 | 0.664 | (phase separation) |
| of the | | average particle | 526 | 519 | 549 | 597 | |
| invention | | size (nm) | | | | | |

As shown in Table 14, separation was observed in Products 12, 13 and 14 or the invention in the 50° C. storage, but nearly no change in turbidity or average particle size was observed in the refrigerated, ambient temperature or 35° C. storage. The emulsions were thus very stable.

### Example 16

### Preparation of Lemon Essential Oil-Blended Emulsions—Investigation in Blend Ratio of OSGA to 70% Aqueous Sorbitol Solution

In the foregoing Examples, investigations were made using 10% aqueous OSGA-sorbitol solution formed by dissolving OSGA at a ratio of 10% in 70% aqueous sorbitol solution. In this Example emulsification was run at varied blend ratio of OSGA to the 70% aqueous sorbitol solution, to compare the resulting emulsification conditions.

As shown in Table 15, blend ratios of TICAMULSION (TIC Gums, Inc.), 70% aqueous sortibol solution and water were varied in each run wherein they were mixed and dissolved at 50-55° C., sterilized by heating at 90-95° C. for 15 minutes, and cooled to 40° C. or lower to provide aqueous OSGA-sorbitol solutions differing in composition.

Next, tocopherol extract, edible oil and fat and SAIB were mixed at 90-95° C., cooled to 30-40° C., and to which lemon essential oil was added to form a weighted oil phase. This weighted oil phase was gradually added to each of above aqueous OSGA-sorbitol solutions, and emulsified with TK-Homomixer (Tokushu Kika Kogyo Co.) at 7,000-8,000 rpm for 15 minutes. Thereafter a mixture of glycerin and soft water was added, followed by further agitation-mixing with TK-Homomixer (Tokushu Kika Kogyo Co.) at 3,000 rpm for 10 minutes, to provide lemon essential oil-blended emulsios (Products 15-18 of the invention).

### Comparative Example 10

### Preparation of Lemon Essential Oil-Blended Emulsion—Investigation in Blend Ratio of OSGA to 70% Aqueous Sorbitol Solution

As shown in Table 15, Example 12 was repeated except that 5% aqueous OSGA-sorbitol solution was used, to provide a lemon essential oil-blended emulsion (Comparative Product 11).

TABLE 15
Composition of Lemon Essential Oil-blended Emulsions

| | | Product | Product | Product | Product | |
|---|---|---|---|---|---|---|
| | | 15 of the | 16 of the | 17 of the | 18 of the | Comparative |
| | | invention | invention | invention | invention | Product 11 |
| Aqueous | OSGA | 37.5 | 75 | 100 | 100 | 25 |
| phase | gum arabic | | | | | |
| | water | | 75 | 100 | 150 | |
| | 70% aqueous | 462.5 | 350 | 300 | 250 | 475 |
| | sorbitol | | | | | |
| | solution | | | | | |
| | 50% aqueous | 50 | 50 | 50 | 50 | 50 |
| | lactic acid | | | | | |
| | solution | | | | | |
| Oil phase | MCT | 47.1 | 47.1 | 47.1 | 47.1 | 47.1 |
| | SAIB | 76.9 | 76.9 | 76.9 | 76.9 | 76.9 |
| | vitamin E | 1 | 1 | 1 | 1 | 1 |
| | lemon | 25 | 25 | 25 | 25 | 25 |
| | essential oil | | | | | |
| Stabilizer | water | 50 | 50 | 50 | 50 | 50 |
| | Glycerin | 250 | 250 | 250 | 250 | 250 |
| | TOTAL | 1000 | 1000 | 1000 | 1000 | 1000 |

### [Evaluation of the Emulsions]

Those lemon essential oil-blended emulsions of Products 15-18 of the invention and Comparative Product 11 were given an optical microscopic observation and measured of turbidity and average particle size. The results were as shown in Table 16. The measurements of average size and the size distribution of the emulsion-dispersed particles were made with Electrophoresis Light-scattering Photometer ELS-8000 Model (Otsuka Electronics Co.).

TABLE 16
Turbidity, Average Particle Size and Results of Optical Microscopic Observation of
Products 15-18 of the Invention and Comparative Product 11

| | | | turbidity | Average | | |
|---|---|---|---|---|---|---|
| | | | (Abs.) | Particle | | |
| | Emulsifying | | (1/2000H₂O, | size | | |
| | agent | Emulsifying method | 680 nm) | (nm) | Optical microscopic observation | Evaluation |
| Product 15 of | OSGA | agitation-emulsified | 0.181 | 625 | Particle size slightly coarse but fairly | ◯ |
| the invention | | | | | uniform-sized and favorable. | |
| Product 16 of | OSGA | agitation-emulsified | 0.102 | 390 | Emulsion particles were very fine and | ⊙ |
| the invention | | | | | favorable. | |
| Product 17 of | OSGA | agitation-emulsified | 0.081 | 325 | Emulsion particles were very fine and | ⊙ |
| the invention | | | | | favorable. | |
| Product 18 of | OSGA | agitation-emulsified | 0.170 | 540 | Particle size slightly coarse but fairly | ◯ |
| the invention | | | | | uniform-sized and favorable. | |
| Comparative | gum arabic | agitation-emulsified | 0.221 | 980 | Emulsion particles coarse and | X |
| Product 11 | | | | | emulsified condition poor. | |

As shown in Table 16, Products 15 and 18 of the invention had slightly coarse particle sizes but showed little size scattering, and were in good emulsion condition.

Products 16 and 17 of the invention had very fine particle sizes and in good emulsion condition.

By contrast, Comparative Product 11 had coarse emulsion particles, and was in poor emulsion condition.

Accordingly, very satisfactorily emulsified condition is found to be obtainable when the blend ratio of OSGA to 70% aqueous sorbitol solution is such that the blend ratio of OSGA to the sum of 70% aqueous sorbitol solution and OSGA lies within the range of from 0.075 to 0.2, as in Products 15-18 of the invention.

1. An emulsified composition which is characterized by comprising
(A) edible oil material
(B) sucrose diacetate hexaisobutyrate (SAIB)
(C) octenylsuccinic acid-modified gum arabic,
(D) polyalcohol
and
(E) water.

2. An emulsified composition according to claim 1, which contains the edible oil material (A), based on the mass of the emulsified composition, within a range of from 0.5 mass % to 50 mass %.

3. An emulsified composition according to claim 1, in which sucrose diacetate hexaisobutyrate (SAIB) (B) has specific gravity within a range of from about 1.13 to about 1.19.

4. An emulsified composition according to claim 1 which contains sucrose diacetate hexaisobutyrate (SAIB) (B) within a range of from 0.01 to 5 mass parts per 1 mass part of edible oil material (A).

5. An emulsified composition according to claim 1, which contains octenylsuccinic acid-modified gum arabic (C) within a range of from 4 mass % to 24 mass % to the mass of the emulsified composition.

6. An emulsified composition according to claim 1, in which the blend ratio of octenylsuccinic acid-modified gum arabic (C) to the sum of octenylsuccinic acid-modified gum arabic (C) and water (E) is within a range of from 0.32 to 0.42.

7. An emulsified composition according to claim 6, which contains an aqueous octenylsuccinic acid-modified gum arabic (C) solution within a range of from 20 to 70 mass % to the mass of the emulsified composition.

8. An emulsified composition according to claim 1, which contains polyalcohol within a range of from 20 to 50 mass % to the mass of the emulsified composition.

9. An emulsified composition according to claim 1, in which the polyalcohol (D) is sorbitol, glycerin, or sorbitol and glycerin.

10. An emulsified composition according to claim 9, in which the blend ratio of water to the sum of sorbitol and water is within a range of from 0.45 to 0.6, and the blend ratio of octenylsuccinic acid-modified gum arabic to the sum of the octenylsuccinic acid-modified gum arabic, sorbitol and water is from 0.045 to 0.30.

11. An emulsified composition according to claim 1, in which the blend ratio of the sum of edible oil material (A) and sucrose diacetate hexaisobutyrate (SAIB) (B) [(A)+(B)] to the sum of octenylsuccinic acid-modified gum arabic (C), polyalcohol (D) and water (E) [(C)+(D)+(E)], [(A)+(B)]/ [(C)+(D)+(E)] is within a range from 0.005 to 0.55.

12. An emulsified composition according to claim 1, in which the difference between the specific gravity of the mixture of edible oil material (A) with sucrose diacetate hexaisobutyrate (SAIB) (B) and that of a beverage in which the emulsified composition is blended is not more than 0.05.

13. Beverage in which the emulsified composition according to claim 1 is blended.

14. A method of preparing an emulsified composition of claim 1, which comprises emulsifying and finely dispersing the oil phase comprising edible oil material (A) and sucrose diacetate hexaisobutyrate (B) into the aqueous phase comprising octenylsuccinic acid-modified gum arabic (C), in the presence of polyalcohol (D).

15. A method of preparing an emulsified composition of claim 1, which comprises preparing an aqueous octenylsuccinic acid-modified gum arabic solution by mixing octenylsuccinic acid-modified gum arabic (C) with water, mixing the aqueous solution with a mixture of edible oil material (A) and sucrose diacetate hexaisobutyrate (SAIB) (B), optionally conducting an emulsifying and dispersing treatment, further mixing therewith polyalcohol (D), or polyalcohol (D) and water, and conducting an emulsifying and dispersing treatment.

16. A method of preparing an emulsified composition of claim 1, which comprises preparing an aqueous octenylsuccinic acid-modified gum arabic solution by mixing octenylsuccinic acid-modified gum arabic (C) with water, mixing the aqueous solution with polyalcohol (D) to form an aqueous octenylsuccinic acid-modified gum arabic-polyalcohol solution, mixing the aqueous solution with a mixture of edible oil material (A) and sucrose diacetate hexaisobutyrate (SAIB) (B), optionally conducting an emulsifying and dispersing treatment, further mixing therewith polyalcohol (D), or polyalcohol (D) and water, and conducting an emulsifying and dispersing treatment.

17. A method of preparing an emulsified composition of claim 1, which comprises mixing polyalcohol (D) with water, mixing the resulting aqueous polyalcohol solution with octenylsuccinic acid-modified gum arabic (C) to prepare an aqueous octenylsuccinic acid-modified gum arabic-polyalcohol solution, adding to the aqueous solution a mixture of edible oil material (A) and sucrose diacetate hexaisobutyrate (SAIB) (B), optionally conducting an emulsifying and dispersing treatment, further mixing therewith polyalcohol (D), or polyalcohol (D) and water, and conducting an emulsifying and dispersing treatment.

18. A method of preparing an emulsified composition according to claim 9, which comprises mixing sorbitol with water, mixing the resulting aqueous sorbitol solution with octenylsuccinic acid-modified gum arabic (C) to prepare an aqueous octenylsuccinic acid-modified gum arabic-sorbitol solution, adding to the aqueous solution a mixture of edible oil material (A) and sucrose diacetate hexaisobutyrate (SAIB) (B), optionally conducting an emulsifying and dispersing treatment, further mixing therewith sorbitol and/or glycerin, or sorbitol and/or glycerin and water, and conducting an emulsifying and dispersing treatment.

19. A method of preparing an emulsified composition according to claim 10, which comprises mixing sorbitol with water, mixing the resulting aqueous sorbitol solution with octenylsuccinic acid-modified gum arabic (C) to prepare an aqueous octenylsuccinic acid-modified gum arabic-sorbitol solution, adding to the aqueous solution a mixture of edible oil material (A) and sucrose diacetate hexaisobutyrate (SAIB) (B), optionally conducting an emulsifying and dispersing treatment, further mixing therewith sorbitol and/or glycerin, or sorbitol and/or glycerin and water, and conducting an emulsifying and dispersing treatment.
